(19) United States
(12) Patent Application Publication
(10) Pub. No.: US 2015/0161613 A1
(43) Pub. Date: Jun. 11, 2015

(54) METHODS AND SYSTEMS FOR AUTHENTICATIONS AND ONLINE TRANSACTIONS

(71) Applicant: TENCENT TECHNOLOGY (SHENZHEN) COMPANY LIMITED, Shenzhen (CN)

(72) Inventor: YUMIAO ZHANG, Shenzhen (CN)

(73) Assignee: TENCENT TECHNOLOGY (SHENZHEN) COMPANY LIMITED

(21) Appl. No.: 14/621,750

(22) Filed: Feb. 13, 2015

Related U.S. Application Data
(63) Continuation of application No. PCT/CN2014/080531, filed on Jun. 23, 2014.

(30) Foreign Application Priority Data
Oct. 31, 2013 (CN) 2013-10530498.8

(51) Int. Cl. G06Q 20/40; G06Q 30/02; G06Q 30/06

(52) U.S. Cl. CPC G06Q 20/40145; G06Q 30/0635; G06Q 30/0222; G06Q 30/0226

(57) ABSTRACT

A method and system for online authentication and payment are disclosed. The method includes collecting facial data of a user in real time, the user being associated with a user account; comparing the collected facial data with facial data associated with the user account; and receiving data related to a purchase order, the purchase order data including a payment account number and a payment amount. The method further includes sending the purchase order data to a payment module and making, by the payment module, a payment based on the purchase order data. The method and system consistent with the present disclosure may authenticate a user before conducting an online transaction and improve the user experience in conducting online transactions.

### CROSS-REFERENCES TO RELATED APPLICATIONS

### Related Applications

This application is a continuation application of PCT Patent Application No. PCT/CN2014/080531, filed on Jun. 23, 2014, which is based upon and claims the benefit of priority from Chinese Patent Application No. 201310530498.8, filed on Oct. 31, 2013, the entire contents of both of which are incorporated herein by reference.

### FIELD OF THE INVENTION

The present disclosure relates to Internet technologies and, more particularly, to methods and systems for authenticating users and making payments online.

### BACKGROUND

Many businesses, such as stores, supermarkets, recreational centers, set up membership programs for its customers. A member of a certain customer club may receive membership benefits such as discounts on purchases. As a result, such clubs encourage its members to make more purchases. Often, when a member is making a purchase, he may need to enter a membership number before he makes a payment so that he can receive the credit for the purchase (e.g., membership points). This process of entering the membership information at the time of transaction may make the operation tedious and inefficient.

The disclosed method and system are directed to solve one or more problems set forth above and other problems.

### BRIEF SUMMARY OF THE DISCLOSURE

Embodiments consistent with the present disclosure provide a method, system, mobile device, or a server for authenticating users and making payments online. Embodiments consistent with the present disclosure enable instant messaging users to complete business transactions efficiently.

One aspect of the present disclosure provides a method for online authentication and payment. The method includes collecting facial data of a user in real time, the user being associated with a user account; comparing the collected facial data with facial data associated with the user account; and receiving data related to a purchase order, the purchase order data including a payment account number and a payment amount. The method further includes sending the purchase order data to a payment module and making, by the payment module, a payment based on the purchase order data. The method and system consistent with the present disclosure may authenticate a user before conducting an online transaction and improve the user experience in conducting online transactions.

Another aspect of the present disclosure provides a method for online authentication and payment. The method may include collecting facial data of a user in real time, the user being associated with a user account; comparing the collected facial data with facial data associated with the user account; receiving data related to a purchase order, the purchase order data including a payment account number and a payment amount; and making a payment based on the purchase order data.

Another aspect of the present disclosure provides a system for online authentication and payment. The system may include an authentication platform configured to collect facial data of a user in real time, the user being associated with a user account; compare the collected facial data with facial data associated with the user account; receive data related to a purchase order, the purchase order data including a payment account number and a payment amount; and send the purchase order data. The system may also include a payment module configured to receive the purchase order data and make a payment based on the purchase order data.

Another aspect of the present disclosure provides a system for online authentication and payment. The system may include a collection unit configured to collect facial data of a user in real time, the user being associated with a user account; a comparing unit configured to compare the collected facial data with facial data associated with the user account; a receiving unit configured to receive data related to a purchase order, the purchase order data including a payment account number and a payment amount; and a sending unit configured to send the purchase order data to a payment platform.

Other aspects of the present disclosure can be understood by those skilled in the art in light of the description, the claims, and the drawings of the present disclosure.

### BRIEF DESCRIPTION OF THE DRAWINGS

To illustrate embodiments of the invention, the following are a few drawings illustrating embodiments consistent with the present disclosure.

FIG. 1 is a flowchart of a method for authenticating user and making payment online implemented by an exemplary embodiment consistent with the present disclosure;

FIG. 2 is an exemplary user interface for entering a purchase order through an online authentication platform implemented by an exemplary embodiment consistent with the present disclosure;

FIG. 3 is another flowchart of a method for authenticating user and making payment online implemented by an exemplary embodiment consistent with the present disclosure;

FIG. 4 is an exemplary server for an online authentication platform consistent with the present disclosure;

FIG. 5 is another exemplary server for an online authentication platform consistent with the present disclosure; and

FIG. 6 is an exemplary system for making online payments consistent with the present disclosure.

### DETAILED DESCRIPTION

Reference will now be made in detail to exemplary embodiments of the invention, which are illustrated in the accompanying drawings. Hereinafter, embodiments consistent with the disclosure will be described with reference to drawings. Wherever possible, the same reference numbers will be used throughout the drawings to refer to the same or like parts. It is apparent that the described embodiments are some but not all of the embodiments of the present invention. Based on the disclosed embodiment, persons of ordinary skill in the art may derive other embodiments consistent with the present disclosure, all of which are within the scope of the present invention.

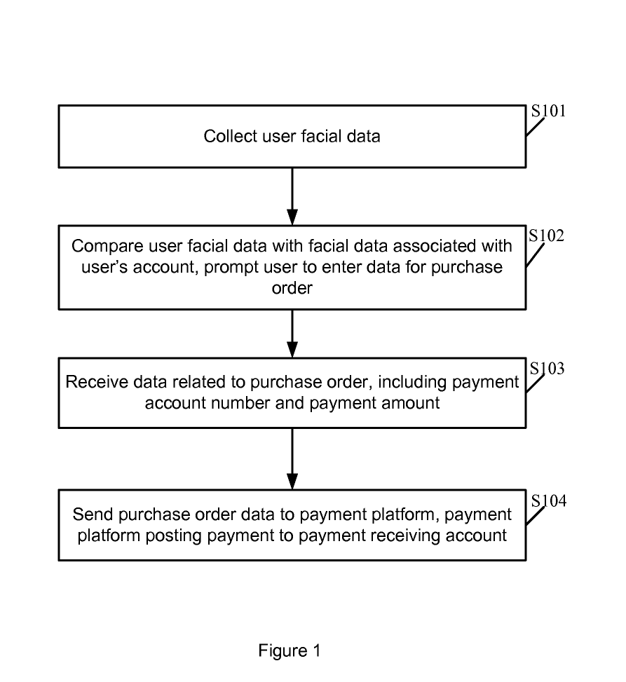

FIG. 1 shows a flow chart of a method for authenticating users and making online payments implemented by embodiments consistent with the present disclosure. Embodiments consistent with the present disclosure may be used in supermarkets, shopping malls, or recreational centers to conduct business transactions. The online authentication platforms consistent with the present disclosure may further be connected to one or more payment platforms. The method shown in FIG. 1 includes steps S101-S104.

In step S101, the server of the online authentication platform may collect a user's facial data. The facial data may be data related to the user's facial profile, facial expressions, etc. Certain biometric data, such as data related to a person's fingerprints or iris, are unique to the person. It is also difficult to duplicate such biometric data. As a result, it is advantageous to use biometric data to authenticate the identity of a user. In embodiments consistent with the present disclosure, the online authentication platform may include an external camera and other data collect devices. As an example, the online authentication platform may collect facial data using the external camera.

In step S102, the server of the online authentication platform may compare the user facial data with the facial data associated with the user's account. If the facial data match, the online authentication platform may prompt the user to enter the data for a purchase order. In embodiments consistent with the present disclosure, the server of the online authentication platform may store the facial data associated with the user accounts. The online authentication platform may compare the user facial data with the facial data associated with the user's account, which are stored on the server. If the facial data match, the online authentication platform may prompt the user to enter the data for a purchase order. Alternatively, the facial data associated with user accounts may be stored in other servers connected to the server of the online authentication platform. In that case, the online authentication platform may compare the user facial data with the facial data associated with the user's account, which are stored in other servers connected to the online authentication platform. If the facial data match, the online authentication platform may prompt the user to enter the data for an order.

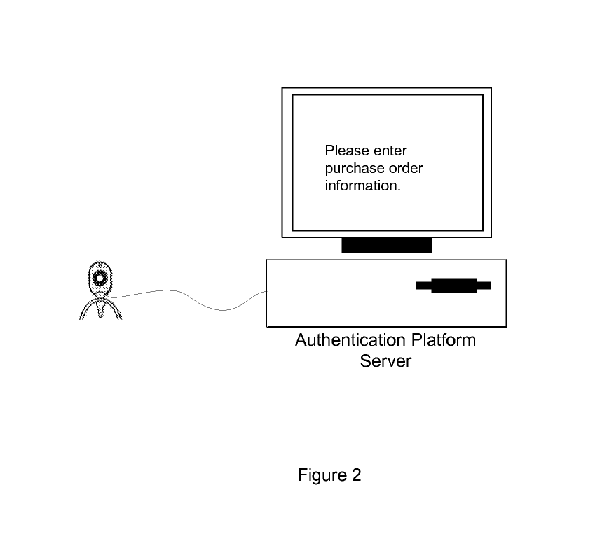

As shown in FIG. 2, the online authentication platform may use a text interface to prompt a user to enter the purchase order. Alternatively, the online authentication platform may use a text and voice combined interface to prompt the user to enter the order by text or audio input. In embodiments consistent with the present disclosure, if the facial data collected by the online authentication platform do not match the facial data associated with the user account, the online platform may show that the authentication process failed, and stop further transaction. In other embodiments, the online platform may show that the authentication process failed, and the user may not receive benefits such as discounts or promotional prices associated with a customer club membership.

In step S103, the server of the online authentication platform may receive the data related to the purchase order from the user. The order data may include a payment account number and a payment amount. Further, the order data may include data related to the goods or services being ordered and other data. In step S104, the server of the online authentication platform may send the received order data to the connected payment platform server. Embodiments consistent with the present disclosure may then complete the payment process. The server of the payment platform, based on the purchase order data, may deduct the payment amount from the specified payment account. Both the payment amount and the payment account number may be included in the purchase order data. The server of the payment platform may further post the payment amount to a payment receiving account. The payment receiving account may be identified by the server of the authentication platform. That is, when a user is registering with the authentication/payment platform, the server of the authentication platform may associate the user account to one or more payment receiving accounts. The server of the payment platform may store the data related to the payment receiving accounts.

In some embodiments consistent with the present disclosure, as shown in FIG. 1, after the server of the authentication platform compares the collected facial data to facial data associated with the user's account, before the server prompts the user to enter data for a purchase order, the server may prompt the user to input fingerprint data. The server may then receive the fingerprint data. The server of online authentication platform may compare the fingerprint data with the fingerprint data associated with the user's account. If the fingerprint data match, the online authentication platform may prompt the user to enter the data for a purchase order. By collecting fingerprint data and authenticating the user using the fingerprint data, embodiments consistent with the present disclosure may authenticate user identities and prevent false claims of customer identity.

In some embodiments consistent with the present disclosure, before executing step S101, the server of the authentication platform may implement the following steps. First, the server of the authentication platform may receive a request for a user registration. Second, the server may collect biometric data of the user, such as facial data, fingerprint data, etc. Third, in response to the request for registration, the server may generate a user account for the user. Fourth, the server may associate the collected biometric data, such as the facial data, the fingerprint data, etc., with the user's account. Finally, the server may send a message to the user indicating the registration is complete. Embodiments consistent with the present disclosure may execute these steps, collect user biometric data during the user registration process, and associate the collected biometric data to the user's account. Embodiments consistent with the present disclosure may thus collect data for the subsequent user authentication process.

In some embodiments consistent with the present disclosure, when implementing the method as shown in FIG. 1, the server for the authentication platform may implement the following process after sending the purchase order data to the payment platform. First, the server of the authentication platform may obtain a past payment total of the user account. Second, the server of the authentication platform may determine a discount rate based on the past payment total amount. For example, if one user has past payments totaling to $10,000-$20,000, the server may determine that the discount rate may be 50%; and if one user has past payments totaling to $5,000-$10,000, the server may determine that the discount may be 80%. Third, the server of the authentication platform may send the determined discount to the server of the payment platform. The server of the payment platform may then apply the discount to the purchase order. Embodiments consistent with the present disclosure may therefore apply discounts to qualified purchases and encourage users to make purchases.

As shown in FIG. 1, embodiments consistent with the present disclosure may simplify the process for entering user account number and perform the online payment operations. Further, embodiments consistent with the present disclosure may be used in stores, shopping malls, and recreational centers that do not have staff for authenticating customers or receiving payments. Embodiments consistent with the present disclosure may relieve staff from manually receiving purchase orders and making payments. Embodiments consistent with the present disclosure may thus improve user experience for online purchases.

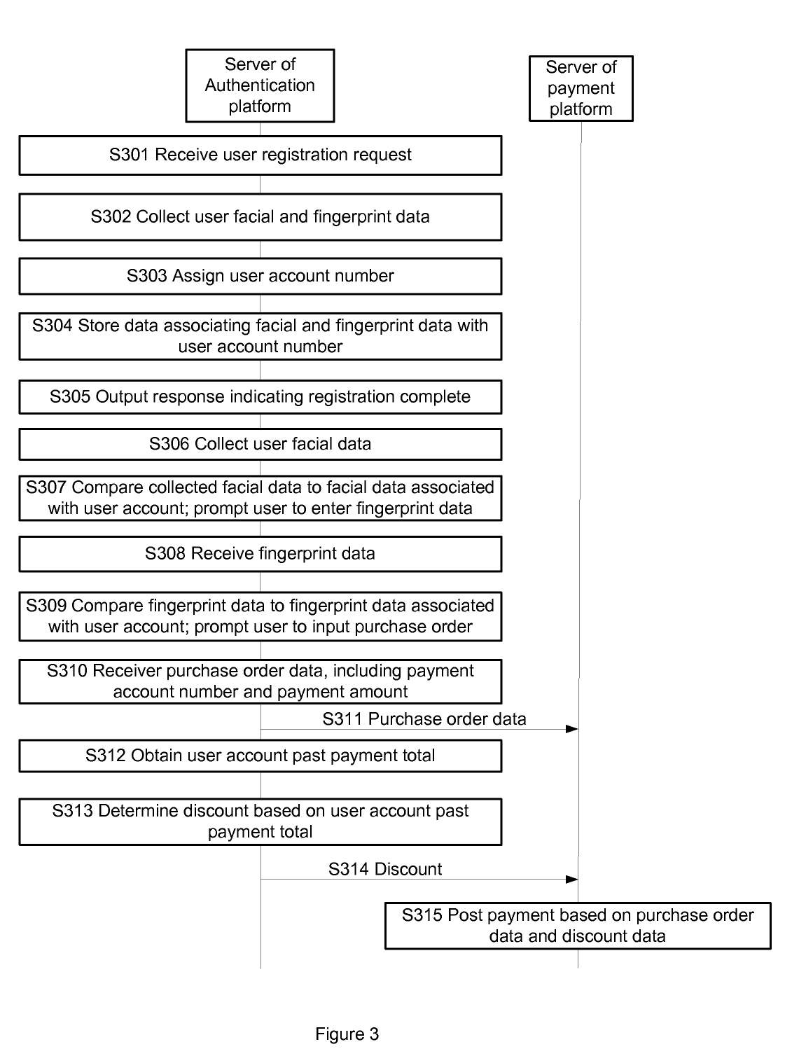

FIG. 3 shows another exemplary flow chart of a method for online payment implemented by embodiments consistent with the present disclosure. As shown in FIG. 3, the method may be implemented by a server of the authentication platform and a server of the payment platform. Embodiments consistent with the present disclosure may be used in supermarkets, shopping malls, or recreational centers. The online authentication platforms consistent with the present disclosure may further be connected to one or more payment platforms. The method shown in FIG. 3 includes steps S301-S315.

In step S301, the server of the authentication platform may receive a user registration request. In step S302, the server may collect biometric data of the user, such as facial data, fingerprint data, etc. In step S303, in response to the request for registration, the server may generate a user account for the user. In step S304, the server may associate the collected biometric data, such as the facial data, the fingerprint data, etc., with the user's account. In step S305, the server may send a message to the user indicating the registration is complete. Embodiments consistent with the present disclosure may execute steps S301-S305, collect user biometric data during the user registration process, and associate the collected biometric data to the user's account. Embodiments consistent with the present disclosure may thus collect data for the subsequent user authentication process. Embodiments consistent with the present disclosure may further store the user's biometric data, and the data related to the association of the biometric data with the user account in a membership database.

In step S306, the server of the online authentication platform consistent with the present disclosure may collect a user's facial data. The facial data may be data related to the user's facial profile, facial expressions, etc. Certain biometric data, such as data related to fingerprints, iris, are unique to a person. It is also difficult to duplicate such biometric data. As a result, it is advantageous to use biometric data to authenticate the identity of a user. In embodiments consistent with the present disclosure, the online authentication platform may include an external camera. The online authentication platform may collect facial data using the external camera.

In step S307, the server of online authentication platform may compare the user facial data with the facial data associated with the user's account. If the facial data match, the online authentication platform may prompt the user to enter the fingerprint data. In embodiments consistent with the present disclosure, if the facial data collected by the online authentication platform do not match the facial data associated with the user account, the online platform may show that the authentication process failed, and stop any further transaction. In other embodiments, the online platform may show that the authentication process failed, and the user may not receive benefits such as discounts or promotional prices.

In step S308, the server may receive the user's fingerprint data. In step S309, the server of online authentication platform may compare the fingerprint data with the fingerprint data associated with the user's account. If the fingerprint data match, the online authentication platform may prompt the user to enter the data for a purchase order. By collecting fingerprint data and authenticating the user using the finger print data, embodiments consistent with the present disclosure may authenticate user identities and prevent false claims of customer identities. In embodiments consistent with the present disclosure, if the fingerprint data collected by the online authentication platform do not match the fingerprint data associated with the user account, the online platform may show that the authentication process failed, and stop further transaction. In other embodiments, the online platform may show that the authentication process failed, and the user may not receive benefits such as discounts or promotional prices.

In embodiments consistent with the present disclosure, the server of the online authentication platform may store the facial data associated with user accounts. The online authentication platform may compare the user facial data with the facial data associated with the user's account, which are stored on the server. If the facial data match, the online authentication platform may prompt the user to enter the data for a purchase order. Alternatively, the facial data associated with user accounts may be stored in other servers connected to the server of the online authentication platform. The online authentication platform may compare the user facial data with the facial data associated with the user's account, which are stored on other servers connected to the online authentication platform. If the facial data match, the online authentication platform may prompt the user to enter the data for an order.

As shown in FIG. 2, the online authentication platform may use text interface to prompt user to enter the order. Alternatively, the online authentication platform may use a text and voice combined interface to prompt the user to enter the purchase order.

In step S310, the server of the online authentication platform may receive the data related to the order from the user. The order data may include a payment account number, and a payment amount. Further, the order data may include data related to the goods being ordered and other data. In step S311, the server of the online authentication platform may send the received order data to the connected payment platform server. In step S312, the server of the authentication platform may obtain past payment total of the user account. In step S313, the server of the authentication platform may determine a discount rate based on the past payment total. For example, if one user has a past payment total of $10,000-$20,000, the server may determine that the discount may be 50%; and if one user has a past payment total of $5,000-$10,000, the server may determine that the discount may be 80%. In step S314, the server of the authentication platform may send the determined discount to the server of the payment platform. In step S315, the server of the payment platform may then apply the discount to the purchase order. Embodiments consistent with the present disclosure may therefore apply discounts to qualified purchases and encourage users to make more purchases.

As shown in FIG. 3, embodiments consistent with the present disclosure may simplify the process for entering user account number and perform the online payment operations. Further, embodiments consistent with the present disclosure may be used in stores, shopping malls, and recreational centers that do not have staff for authenticating customers or receiving payments. Embodiments consistent with the present disclosure may relieve staff from manually receiving purchase orders and making payments. Embodiments consistent with the present disclosure may thus improve user experience for online purchases.

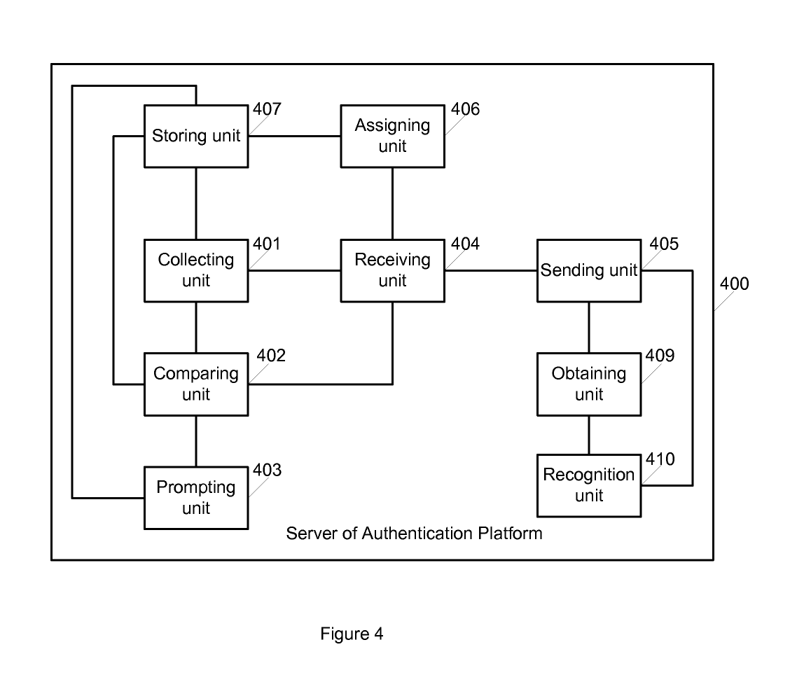

FIG. 4 shows a schematic diagram of a server of the authentication platform consistent with the present disclosure. Embodiments consistent with the present disclosure may be used in supermarkets, shopping malls, or recreational centers. The online authentication platforms consistent with the present disclosure may further be connected to one or more payment platforms. As shown in FIG. 4, the server 400 of the authentication platform may include a collection unit 401, a comparing unit 401, a prompting unit 403, a receiving unit 404, and a sending unit 405. The collection unit 401 may collect a user's facial data. The comparing unit 402 may compare the collected facial data with the facial data associated with the user account. The prompting unit 403 may prompt the user to enter data for the purchase order if the collected facial data match the facial data associated with the user account. The receiving unit 404 may receive the purchase order data. The purchase order data may include a payment account number and a payment amount. The sending unit 405 may send the purchase order data to the payment platform. The payment platform may then make the payment based on the purchase order data.

Further, the prompting unit 403 may also prompt the user to enter fingerprint data after the comparing unit 402 determines that the collected facial data match the facial data associated with the user account. The receiving unit 404 may then receive the fingerprint data. The comparing unit 402 may then compare the collected fingerprint data to the fingerprint data associated with the user account. If the fingerprint data match, then the prompting unit 403 may prompt the user to enter data for the purchase order.

In addition, the server 400 of the authentication platform shown in FIG. 4 may include an assigning unit 406 and a storing unit 407. The server 400 of the authentication platform may receive a request for a user registration. In response to the request for registration, the assigning unit 406 may generate and assign a user account to the user. The storing unit 407 may store the data associating the biometric data collected by collection unit 401, such as the facial data, the finger print data, etc., to the user's account assigned by assigning unit 406. Thereafter, the prompting unit 403 may send a message to the user indicating the registration is complete. In this embodiment, the comparing unit 402 may compare the facial data collected by collection unit 401 to the facial data associated with the user account to determine whether they match.

Moreover, the server 400 of the authentication platform shown in FIG. 4 may include an obtaining unit 409 and a recognition unit 410. The obtaining unit 409 may obtain the payments of the user account after the sending unit 405 sends the purchase order data to the payment platform. The recognition unit 410 may recognize the total of the user account's past payments and determine a discount for the past payment total amount. The sending unit 405 may send the discount determined by the recognition unit 410 to the payment platform so that the payment platform may apply the discount to the payment.

As shown in FIG. 4, embodiments consistent with the present disclosure may simplify the process for entering user account number and perform the online payment operations. Further, embodiments consistent with the present disclosure may be used in stores, shopping malls, and recreational centers that do not have staff for authenticating customers or receiving payments. Embodiments consistent with the present disclosure may relieve staff from manually receiving purchase orders and making payments. Embodiments consistent with the present disclosure may thus improve user experience for online purchases.

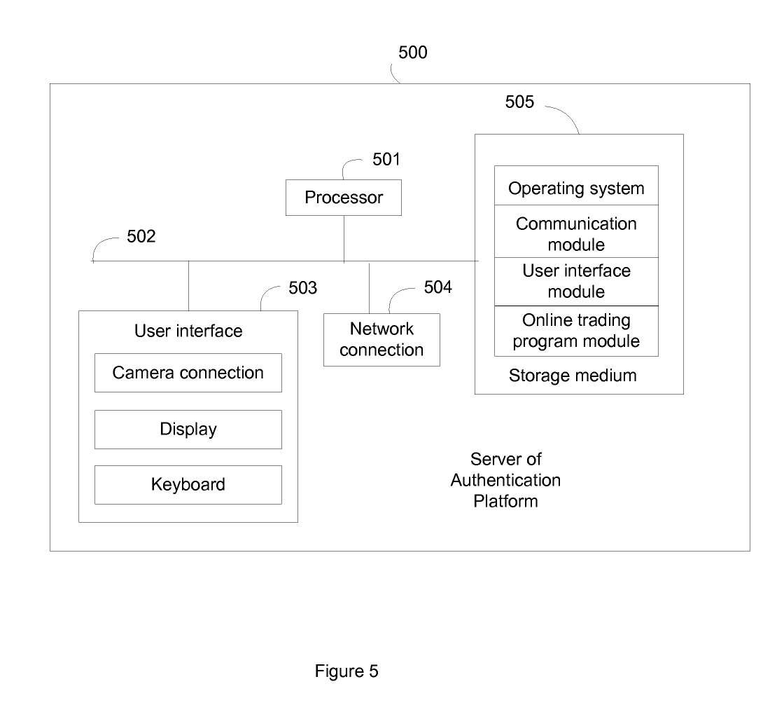

FIG. 5 is another schematic diagram of a server of the authentication platform consistent with the present disclosure. As shown in FIG. 5, the server 500 of the authentication platform may include a processor 501, such as a CPU, a network connection 504, a user interface 503, storage medium 505, and a bus 502. Processor 501 may include any appropriate processor or processors. Further, processor 501 can include multiple cores for multi-thread or parallel processing. Storage medium 505 may include memory modules, such as Read-only Memory (ROM), Random Access Memory (RAM), flash memory modules, and erasable and rewritable memory, and mass storages, such as CD-ROM, U-disk, and hard disk, etc. Storage medium 505 may store computer programs for implementing various processes, when executed by processor 501, including the operating system, communication program modules, and other application modules used to implement the system for online authentication and payment consistent with the present disclosure. The network connection 504 may connect to any appropriate type of communication networks, including the Internet, LAN (Local Area Network), or other types of computer networks or telecommunication networks, either wired or wireless. For example, the network connection 504 may connect the online authentication platform to the payment platform, so that a user may complete transactions seamlessly.

In addition, the processor 501 may execute the application programs stored in storage medium 505 to implement online authentication functions. The server of the authentication platform may collect facial data from a user through user interface 503. The server may compare the collected facial data with the facial data associated with the user account. The server may use the user interface 503 to prompt the user to enter data for the purchase order if the collected facial data match the facial data associated with the user account. The server may use the user interface 503 to receive the purchase order data. The purchase order data may include a payment account number and a payment amount. The server may use the network connection 504 to send the purchase order data to the payment platform. The payment platform may then make the payment based on the purchase order data.

Further, the server may, through the user interface 503, prompt the user to enter fingerprint data after determining that the collected facial data match the facial data associated with the user account. The user interface 503 may then receive the fingerprint data. The server may then compare the collected fingerprint data to the fingerprint data associated with the user account. If the fingerprint data match, then the server, through the user interface 503, may prompt the user to enter data for the purchase order.

In addition, the server of the authentication platform shown in FIG. 5 may receive a request for a user registration through user interface 503. In response to the request for registration, the server may generate and assign a user account to the user. The server may store, in storage medium 505, the data associating the biometric data collected through user interface 503, such as the facial data, the finger print data, etc., with the user's account. Thereafter, the user interface 503 may send a message to the user indicating the registration is complete.

Moreover, the server of the authentication platform shown in FIG. 5 may send the purchase order data through the network connection 504 to the payment platform. The server may obtain the past payments of the user account. The server may determine a discount for the past payment total amount. The server may send the discount data through the network connection 504 to the payment platform so that the payment platform may apply the discount to the payment.

As shown in FIG. 5, embodiments consistent with the present disclosure may simplify the process for entering user account number and perform the online payment operations. Further, embodiments consistent with the present disclosure may be used in stores, shopping malls, and recreational centers that do not have staff for authenticating customers or receiving payments. Embodiments consistent with the present disclosure may relieve staff from manually receiving purchase orders and making payments. Embodiments consistent with the present disclosure may thus improve user experience for online purchases.

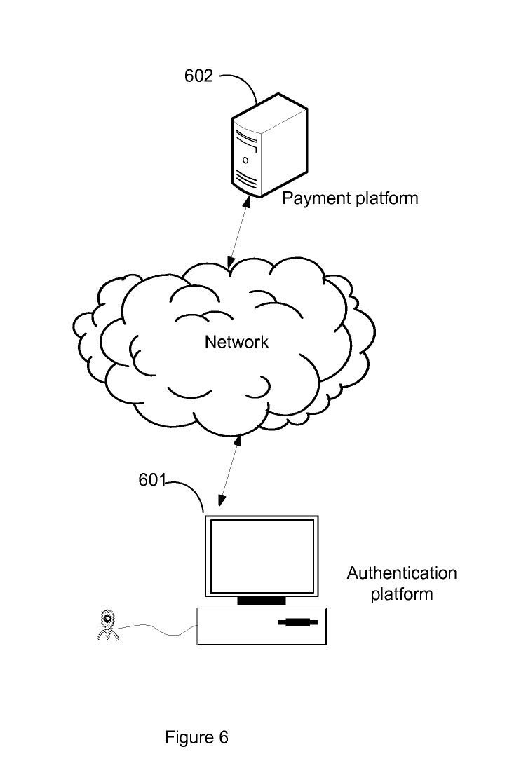

FIG. 6 is another schematic diagram of a system for online authentication and payment consistent with the present disclosure. As shown in FIG. 6, the system for online authentication and payment may include an online authentication platform 601, a payment platform 602. The authentication platform 601 and payment platform 602 may be connected by a network.

The authentication platform 601 may collect facial data from a user. The authentication platform 601 may compare the collected facial data with the facial data associated with the user account. The authentication platform 601 may prompt the user to enter data for the purchase order if the collected facial data match the facial data associated with the user account. The authentication platform 601 may receive the purchase order data. The purchase order data may include a payment account number and a payment amount. The authentication platform 601 may send the purchase order data to the payment platform 602 through the network. The payment platform 602 may then make the payment based on the purchase order data.

Further, the authentication platform 601 may prompt the user to enter fingerprint data after determining that the collected facial data match the facial data associated with the user account. The authentication platform 601 may then receive the fingerprint data. The authentication platform 601 may then compare the collected fingerprint data to the fingerprint data associated with the user account. If the fingerprint data match, then the authentication platform 601 may prompt the user to enter data for the purchase order.

In addition, the authentication platform 601 shown in FIG. 6 may receive a request for a user registration. In response to the request for registration, the authentication platform 601 may generate and assign a user account to the user. The authentication platform 601 may store the data associating the biometric data collected from the user, such as the facial data, the fingerprint data, etc., with the user's account. Thereafter, the authentication platform 601 may send a message to the user indicating the registration is complete.

Moreover, the authentication platform 601 shown in FIG. 6 may send the purchase order data through the network to the payment platform 602. The authentication platform 601 may obtain the past payments of the user account. The authentication platform 601 may determine a discount for the past payment total amount. The authentication platform 601 may send the discount data through the network to the payment platform 602 so that the payment platform 602 may apply the discount to the payment.

As shown in FIG. 6, embodiments consistent with the present disclosure may simplify the process for entering user account number and perform the online payment operations. Further, embodiments consistent with the present disclosure may be used in stores, shopping malls, and recreational centers that do not have staff for authenticating customers or receiving payments. Embodiments consistent with the present disclosure may relieve staff from manually receiving purchase orders and making payments. Embodiments consistent with the present disclosure may thus improve user experience for online purchases.

Consistent with embodiments of the present disclosure, one or more non-transitory storage medium storing a computer program are provided to implement the system and method for sending and receiving alerts. The one or more non-transitory storage medium may be installed in a computer or provided separately from a computer. A computer may read the computer program from the storage medium and execute the program to perform the methods consistent with embodiments of the present disclosure. The storage medium may be a magnetic storage medium, such as hard disk, floppy disk, or other magnetic disks, a tape, or a cassette tape. The storage medium may also be an optical storage medium, such as optical disk (for example, CD or DVD). The storage medium may further be semiconductor storage medium, such as DRAM, SRAM, EPROM, EEPROM, flash memory, or memory stick.

Other embodiments of the disclosure will be apparent to those skilled in the art from consideration of the specification and practice of the invention disclosed herein. It is intended that the specification and examples be considered as exemplary only, with a true scope and spirit of the invention being indicated by the claims.

### INDUSTRIAL APPLICABILITY AND ADVANTAGEOUS EFFECTS

Without limiting the scope of any claim and/or the specification, examples of industrial applicability and certain advantageous effects of the disclosed embodiments are listed for illustrative purposes. Various alternations, modifications, or equivalents to the technical solutions of the disclosed embodiments can be obvious to those skilled in the art and can be included in this disclosure.

By using the disclosed methods and systems, various systems for online transactions may be implemented. For example, users in an instant messaging session may use an online authentication platform to purchase services and/or products. The authentication platform may have a user interface through the instant messaging session. The device hosting the instant messaging session may include a camera, a touch pad, or other communication modules. The online authentication platform may collect biometric data, such as facial data, fingerprint data, iris image data, when a user engages the online authentication system. The online authentication platform may then authenticate the user based on the collected biometric data. Once the authentication platform has authenticated the user, it may prompt the user to enter data for an online transaction. The online transaction may be purchasing one or more products or services, submitting documents, making payments, etc. The authentication platform may be connected to a payment platform or other platforms, such as an information-sharing portal, a social network site, etc. An exemplary instant messaging system may be Tencent's WeChat system. The instant messaging session may be hosted on any type of computing devices, including laptops, tablets, smartphones, etc.

By authenticating users and enabling business transactions online, the system for online authentication and payment consistent with the present disclosure provides users with an enriched user experience.

What is claimed is:

1. A method for online authentication and payment, comprising:
collecting facial data of a user in real time, the user being associated with a user account;
comparing the collected facial data with facial data associated with the user account;
receiving data related to a purchase order, the purchase order data including a payment account number and a payment amount;
sending the purchase order data to a payment module; and
receiving data indicating that the payment module has made a payment based on the purchase order data.

2. The method according to claim 1, the method further comprising:
prompting the user to provide fingerprint data;
receiving the fingerprint data; and
comparing the fingerprint data with fingerprint data associated with the user account.

3. The method according to claim 2, the method further comprising:
receiving a request for registration from the user;
receiving facial data and fingerprint data from the user;
generating the user account for the user;
associating the received facial data with the user account;
associating the received fingerprint data with the user account; and
sending a message to the user indicating the registration is complete.

4. The method according to claim 3, the method further comprising:
obtaining past payment amounts of the user account;
determining a discount rate based on the past payment amounts; and
sending the discount rate to the payment module for making the payment.

5. A method for online authentication and payment, comprising:
collecting facial data of a user in real time, the user being associated with a user account;
comparing the collected facial data with facial data associated with the user account;
receiving data related to a purchase order, the purchase order data including a payment account number and a payment amount; and
making a payment based on the purchase order data.

6. The method according to claim 5, the method further comprising:
prompting the user to provide fingerprint data;
receiving the fingerprint data; and
comparing the fingerprint data with fingerprint data associated with the user account.

7. The method according to claim 6, the method further comprising:
receiving a request for registration from the user;
receiving facial data and fingerprint data from the user;
generating the user account for the user;
associating the received facial data with the user account;
associating the received fingerprint data with the user account; and
sending a message to the user indicating the registration is complete.

8. The method according to claim 7, the method further comprising:
obtaining past payment amounts of the user account;
determining a discount rate based on the past payment amounts; and
making the payment based on the discount rate.

9. A system for online authentication and payment, comprising:
an authentication module configured to collect facial data of a user in real time, the user being associated with a user account; to compare the collected facial data with facial data associated with the user account; to receive data related to a purchase order, the purchase order data including a payment account number and a payment amount; and to send the purchase order data; and
a payment module configured to receive the purchase order data and make a payment based on the purchase order data.

10. The system according to claim 9, wherein the authentication module is further configured to prompt the user to provide fingerprint data; to receive the fingerprint data; and to compare the fingerprint data with fingerprint data associated with the user account.

11. The system according to claim 10, wherein the authentication module is further configured to receive a request for registration from the user; to receive facial data and fingerprint data from the user; to generate the user account for the user; to associate the facial data with the user account; to associate the fingerprint data with the user account; and to send a message to the user indicating the registration is complete.

12. The system according to claim 11, wherein the authentication module is further configured to obtain past payment amounts of the user account; and to determine a discount rate based on the past payment amounts.

13. The system according to claim 12, wherein the payment module is further configured to make the payment based on the discount rate.

14. An online authentication platform facilitating online authentication and payment, comprising:
a collection unit configured to collect facial data of a user in real time, the user being associated with a user account;
a comparing unit configured to compare the collected facial data with facial data associated with the user account;
a receiving unit configured to receive data related to a purchase order, the purchase order data including a payment account number and a payment amount; and
a sending unit configured to send the purchase order data to a payment platform.

15. The online authentication platform according to claim 14, further comprising:
a prompting unit configured to prompt the user to provide fingerprint data;
wherein the receiving unit is further configured to receive the fingerprint data.

16. The online authentication platform according to claim 15, wherein the comparing unit is further configured to compare the fingerprint data with fingerprint data associated with the user account.

17. The online authentication platform according to claim 16, wherein the receiving unit is further configured to receive a request for registration from the user and to receive facial data and fingerprint data from the user.

18. The online authentication platform according to claim 17, further comprising:
an assigning unit configured to assign the user account to the user;
wherein the assigning unit is further configured to associate the received facial data with the user account and the received fingerprint data with the user account.

19. The online authentication platform according to claim 18, wherein the sending unit is further configured to send a message to the user indicating the registration is complete.

20. The online authentication platform according to claim 19, further comprising:
an obtaining unit configured to obtain past payment amounts of the user account; and
a recognition unit configured to determine a discount rate based on the past payment amounts;
wherein the payment platform makes the payment based on the discount rate.
